(19) United States
(12) Patent Application Publication
(10) Pub. No.: US 2018/0014524 A1
(43) Pub. Date: Jan. 18, 2018

(54) Insect Lure and Trap

(71) Applicant: Trece, Inc., Adair, OK (US)

(72) Inventors: John Wesley Peterson, Tulsa, OK (US); Vincent Chebny, Tulsa, OK (US); Clive A Henrick, Palo Alto, CA (US); Bill Wayne Lingren, Oklahoma City, OK (US)

(21) Appl. No.: 15/547,785

(22) PCT Filed: Feb. 1, 2016
(86) PCT No.: PCT/US16/15999

§ 371 Date: Jul. 31, 2017

Related U.S. Application Data
(60) Provisional application No. 62/110,599, filed on Feb. 1, 2015.
(60) Provisional application No. 62/117,116, filed on Feb. 17, 2015.

(51) Int. Cl. A01M 1/02

(52) U.S. Cl. CPC A01M 1/02

(57) ABSTRACT

An insect trap and multi-compartment lure. The multi-compartment lure including several insect attracting compounds separated into different compartments. The insect attracting compounds optionally configured to attract Spotted Wing Drosophila (Drosophila suzukii). The multi-compartment lure including seals configured to prevent some of the insect attracting compounds from mixing prior to use.

### CROSS-REFERENCE TO RELATED APPLICATIONS

This application is a 371 of PCT/US16/15999 filed Feb. 1, 2016, PCT/US16/15999 claims benefit of and priority to U.S. provisional patent application Ser. No. 62/110,599 filed Feb. 1, 2015 and U.S. provisional patent application Ser. No. 62/117,116 filed Feb. 17, 2015. The disclosures of the above applications are hereby incorporated herein by reference.

### BACKGROUND

### Field of the Invention

The invention is in the fields of insect lures and insect traps.

### Related Art

Trapping insects has many useful functions including insect elimination and population monitoring. Traps often include in insect lure configured to attract insects to the trap.

### SUMMARY

The invention includes a lure, e.g., a device including an attractant, configured to attract insects. The lure is optionally incorporated within an insect trap and includes multiple attractant compounds.

In various embodiments of the invention, the lure includes a container having two, three, four or more separated compartments. Each of these compartments is configured to hold one or more attractant compounds.

In those embodiments including two or more compartments, acidic compounds are disposed in a first compartment and alcohol compounds are disposed in a second compartment. The compounds disposed in the first compartment are different than those disposed in the second compartment. The first and second compartments are optionally sealed from each other such that the acidic and alcohol compounds do not mix other than in inconsequential trace amounts. Further, the first and second compartments optionally include different diffusion membranes configured such that rates of diffusion from each of the compartments are individually and separately controllable.

In those embodiments including three or more compartments, different compounds are disposed in at least a first, a second and a third compartment. The first, second and third compartments are optionally sealed from each other such that the compounds within each compartment do not mix significantly with each other. The first, second and third compartments optionally include two or three different diffusion membranes configured such that rates of diffusion from the compartments are individually and separately controllable.

In some embodiments, the compounds disposed in the various compartments discussed herein are configured to attract Spotted wing drosophila (Drosophila suzukii).

Various embodiments of the invention include an insect lure device comprising: a shell including a first compartment and a second compartment, the first and second compartment being configured to hold attractant compounds; two or more attractant compounds, the attractant compounds including one or more acidic attractant compounds and one or more alcohol attractant compounds including an alcohol, the acidic attractant compounds being disposed in the first compartment and the alcohol attractant compounds being disposed in the second compartment; a first diffusion membrane configured to control release of the acidic attractant compounds and the alcohol attractant compounds from the lure; and a removable sealing layer configured to seal the first compartment and the second compartment.

2. Various embodiments of the invention include an insect trap device comprising: a container configured to trap insects; a first compartment including one or more acidic attractant compounds configured to attract insects; a first diffusion membrane configured to limit diffusion of the one or more acidic attractant compounds from the first compartment; a second compartment including one or more alcohol attractant compounds configured to attract insects; a second diffusion membrane configured to limit diffusion of the one or more alcohol attractant compounds from the second compartment; a removable sealing layer configured to limit chemical reactions between the one or more acidic attractant compounds and the one or more alcohol attractant compounds.

Various embodiments of the invention include an insect lure comprising: a shell including a first compartment, a second compartment and a third compartment; a first insect attractant compound disposed in the first compartment; a second insect attractant compound disposed in the second compartment; a third insect attractant compound disposed in the third compartment, the first, second and third insect attractant compounds being different; a first diffusion membrane configured to control diffusion of the first insect attractant from the first compartment; and a removable sealing layer configured to prevent release of the first insect attractant and the second insect attractant.

Various embodiments of the invention include an insect lure device comprising: a first compartment, a second compartment and a third compartment; a first insect attractant compound disposed in the first compartment; a second insect attractant compound disposed in the second compartment; a third insect attractant compound disposed in the third compartment, the first, second and third insect attractant compounds being different; a first diffusion membrane configured to control diffusion of the first insect attractant from the first compartment; a seal between the first and second compartments configured to limit chemical reactions between the first insect attractant and the second insect attractant; and a removable sealing layer configured to seal the first, second and third compartments.

Various embodiments of the invention include an insect lure device comprising: a first compartment, a second compartment and a third compartment; a first insect attractant compound disposed in the first compartment; a second insect attractant compound disposed in the second compartment; a third insect attractant compound disposed in the third compartment, the first, second and third insect attractant compounds being different; a first diffusion membrane configured to control diffusion of the first insect attractant from the first compartment; a seal between the first and second compartments configured to control flow of the first insect attractant into the second compartment; and a removable sealing layer configured to limit release of the first, second and third insect attractants from the lure.

Various embodiments include method of producing an insect lure, the method comprising: receiving a shell including at least a first compartment and a second compartment; placing a first insect attractant in the first compartment; placing a second insect attractant in the second compartment; applying a first diffusion membrane to the first compartment, the first diffusion membrane being configured to limit diffusion of the first insect attractant from the first compartment; applying a second diffusion membrane to the second compartment, the second diffusion membrane being configured to limit diffusion of the second insect attractant from the second compartment; applying a removable sealing layer to the insect lure, the removable sealing layer being configured to seal the first and second compartments; and creating a seal between the first compartment and the second compartment, the seal being configured to limit a chemical reaction between the first insect attractant and the second insect attractant.

Various embodiments of the invention include an insect trap device comprising: a container including a first compartment, a second compartment and a third compartment; a first insect attractant compound disposed in the first compartment; a second insect attractant compound disposed in the second compartment, the first and second compartments being attached to the container; a first diffusion membrane configured to control diffusion of the first insect attractant from the first compartment; and a second diffusion membrane configured to control diffusion of the second insect attractant from the second compartment. These embodiments optionally further include a third insect attractant compound disposed in the third compartment, the first, second and third insect attractant compounds being different; and a third diffusion membrane configured to control diffusion of the third insect attractant from the third compartment.

### BRIEF DESCRIPTION OF THE DRAWINGS

FIG. 1A illustrates a three compartment lure, according to various embodiments of the invention.

FIG. 1B illustrates a two compartment lure, according to various embodiments of the invention.

FIG. 1C illustrates an exploded view of a lure compartment, according to various embodiments of the invention.

FIG. 2 illustrates the outer shell of a three compartment lure, according to various embodiments of the invention.

FIG. 3 illustrates an assembled three compartment lure, according to various embodiments of the invention.

FIG. 4 illustrates a three compartment lure disposed with an insect trap, according to various embodiment of the invention.

FIG. 5 illustrates attachment points of a diffusion membrane, according to various embodiments of the invention.

FIG. 6 illustrates attachment points of a sealing layer, according to various embodiments of the invention.

FIG. 7 illustrates an overlay of seals, according to various embodiments of the invention.

FIG. 8 illustrates methods of producing a lure and trap, according to various embodiments of the invention.

FIGS. 9A and 9B illustrate insect traps including one or more lures, according to various embodiments of the invention.

### DETAILED DESCRIPTION

Embodiments of the invention include a lure including two or more insect attractants. The lure is optionally placed in an insect trap. Features of the lure enable the use of insect attractants that would adversely react chemically with each other. For example, an acidic attractant compound could react with an alcohol based attractant compound to form an ester. These reaction products can be less effective as attractants than their precursors. Thus, if such reactions are allowed to occur, the efficacy of the lure is reduced. This can result in a dramatically reduced shelf life for the lure. Reduced shelf life is avoided by placing attractants in different compartments and severely limiting diffusion of attractants between the compartments. Lures of the invention can include two, three, four or more compartments. The compartments may or may not be directly attached to each other.

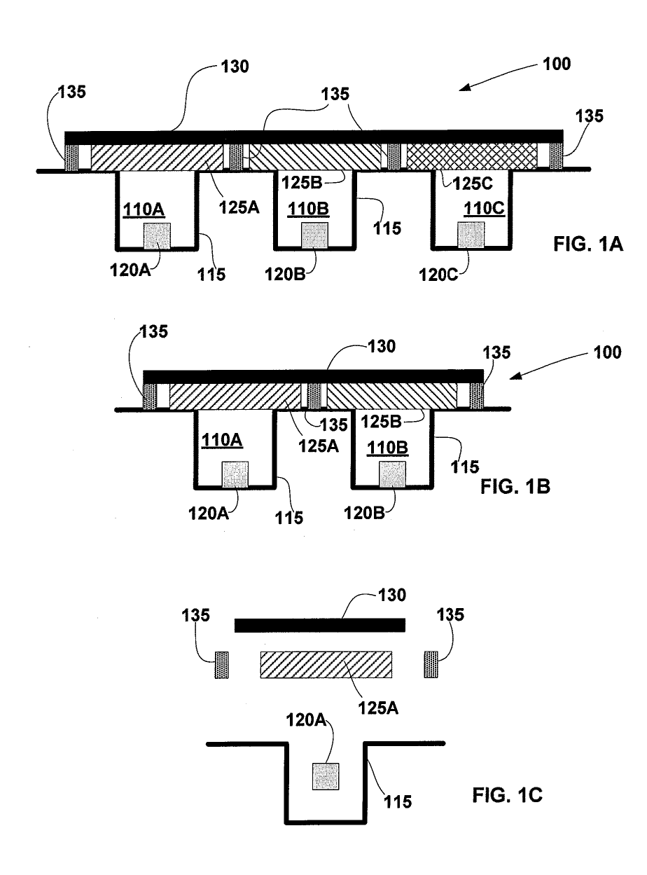

FIG. 1A illustrates a three compartment Lure 100, according to various embodiments of the invention. The three compartment embodiments of Lure 100 include three Compartments 110 individually labeled 110A, 110B and 110C. Each Compartment 110 is formed by an outer Shell 115 and includes a different insect Attractant 120, individually labeled 120A, 120B and 120C. Each Compartment 110 further includes a Diffusion Membrane 125, individually labeled 125A, 125B and 125C. The Diffusion Membranes 125 are disposed between the Compartments 110 and a removable Sealing Layer 130. In some embodiments, Seals 135 are disposed between Sealing Layer 130 and Shell 115. The elements illustrated in FIGS. 1A-1C are not to scale.

Compartments 110 may have curved and/or flat sides. For example, in various embodiments Compartments 110 are cylindrical, hemispherical, or rectangular. Shell 115 can be formed from a wide variety of materials, such as plastic or coated paper. A single connected Shell 115 may form all three Compartments 110 making the Compartments 110 directly connected to each other. Alternatively, two or more of the Compartments 110 may be formed from different Shells 115. If formed from different Shells 115, Compartment 110A can be disposed in a different part of an insect trap. In some embodiments, Shell 115 is also part of the structure of an insect trap, e.g., a trap lid, wall or bottom of the insect trap.

Diffusion Membrane 125 is configured to control the rates diffusion of Attractants 120 from within Compartments 110. In various embodiments, Diffusion Membranes 125 are less than 50, 10, 5 and 2 thousandths of an inch thick. In contrast, the openings of Compartments 110 covered by Diffusion Membranes 125 may be on the order of ¼ to ½ to ¾ inches (or more) in length or diameter. Part of Diffusion Membranes 125 may be masked by a less (non) permeable material so as to reduce the active diffusion area from one or more of Compartments 110. In various embodiments, the active diffusion area and/or openings of Compartments 110 are less than 0.1, 0.2, 0.3, 0.5, 0.6 or 0.7 inches in length or diameter, or any range between these values. In FIGS. 1A-1C Diffusion Membranes 125 are shown with different aspect ratios for illustrative purposes only. Examples of materials that may be used in Diffusion Membranes 125 are provided in Table I. These materials can be combined as would be understood by one of ordinary skill in the art.

TABLE I
Membrane Materials
Membrane Materials

| | | |
|---|---|---|
| polyvinyl alcohol | polyacrylamide | polyurea |
| polyethylene | polyether | epoxy |
| polypropylene | polyester | ethylene vinyl acetate |
| | | copolymer |
| polystyrene | polyamide | Polyvinylacetate |
| polyvinylidene | polyvinyl chloride | Polyacrylate |
| chloride | | |
| polyacrylonitrile | chlorinated polyethylene | acetal copolymer |
| polyurethane | polyvinylpyrrolidone | polymethylmethacrylate |

Other materials that may be used as membranes include, but are not limited to:

1) Polyolefins, including low-, linear low-, and high-density polyethylene (LDPE, LLDPE, HDPE), polypropylene (PP), and biaxially oriented polypropylene (BOPP)

2) Copolymers of ethylene, like ethylene-vinyl acetate (EVA), ethylene-vinyl alcohol (EVOH), and ethylene-acrylic acid (EAA)

3) Substituted olefins, like polystyrene (PS), high-impact polystyrene (HIPS, with 1,3-butadiene isomer added during the polymerization of the PS), oriented polystyrene (OPS), poly(vinyl alcohol) (PVOH), poly(vinyl chloride) (PVC), and poly(vinylidene chloride) (PVdC), and poly(tetrafluoroethylene) (PTFE)

4) Polyesters, like polyethylene terephthalate (PET), polyethylene naphthalate (PEN), and relative copolymer PET-PEN;(v)polycarbonates (PC)

5) Polyamide (PA)

6) Acrylonitriles, like polyacrylonitrile (PAN) and acrylonitrile/styrene (ANS)

7) Regenerated cellulose

8) Polylactic acid (PLA) as biodegradable polymer for food packaging contact

9) Blending, layering or lamination of with any plastic film listed above

Different Diffusion Membranes 125 can be used to cover different members of Compartments 110. The Diffusion Membranes 125 may differ in material or thickness. The selection of Diffusion Membranes 125 can be made so as to control diffusion rates of different members of Attractants 120. In some embodiments, Diffusion Membranes 125B and 125C are the same, while Diffusion Membranes 125A is different. In some embodiments, each of Diffusion Membranes 125A, 125B and 125C are different. Diffusion Membranes 125A, 125B and/or 125C may be a single piece that spans the respective members of Compartments 110. Typically thicknesses for Diffusion Membrane 125 are at less than 0.1 mils, 5 mils, 10, mils, 25 mils, 50 mils, 100 mils, or any range between these values. Any combination of the membrane materials disclosed herein may be used for Diffusion Membranes 125A, 125B and/or 125C. One of Compartments 110 may have a different membrane than the other one or two Compartments 110, or all three of Compartments 110 may have different membranes.

The diffusion occurs through a region of each of Diffusion Membranes 125A, 125B and 125C referred to as the “active diffusion area.” The size of this active diffusion area can be controlled by masking and/or by the diameter/dimensions of Compartments 110. In some embodiments the different Diffusion Membranes 125A-125C have different active diffusion areas. For example, Diffusion Membrane 125A over Compartment 110A may have a 50% greater active diffusion area relative to Diffusion Membrane 125B over Compartment 110B. In various embodiments, the active diffusion area of one of Diffusion Membranes 125A-125C is at least 25%, 50%, 100%, 200% or 300% greater than the active diffusion area of another of Diffusion Membranes 125A-125C. Differences in active diffusion areas are optionally used to control relative release rates of different lures.

Removable Sealing Layer 130 is configured to prevent significant amounts of Attractants 120 from escaping from Lure 100, prior to removal of this layer. For example, Sealing Layer 130 may comprise a foil film that provides an airtight or essentially airtight seal to Compartments 110. Sealing Layer 130 is attached in a removable fashion such that it can be peeled away leaving Diffusion Membranes 125 in place. Removable attachment of Sealing Layer 130 may be performed thermally or using an adhesive. Removal of Sealing Layer 130 allows Attractants 120 to diffuse from Lure 100 and attract insects. When attached, Sealing Layer 130 also limits (e.g., effectively prevents) diffusion of Attractants 120 between Compartments 110. For example, Sealing Layer 130 helps prevent Attractant 120B from reaching and reacting significantly with Attractants 120A or 120C. As used herein, a “significant” chemical reaction is one that results in commercially relevant degradation of the lure. In one example, a significant chemical reaction is one that would reduce the efficacy of the attractants by more than 10% at room temperature in 6 months.

Seals 135 are also configured for preventing mixing of Attractants 120. Seals 135 form a barrier between Compartments 110, and optionally between Compartments 110 and the exterior of Lure 100. Seals 135 may or may not penetrate Diffusion Membranes 125. Seals 135 may comprise an adhesive, plastic or other material. Alternatively, Seals 135 may be formed by heating and/or pressing on Sealing Layer 130 and/or Diffusion Membranes 125. For example, Seals 135 may be formed by a combination of pressure and heat that causes melting of Sealing Layer 130 and/or Diffusion Membranes 125. Seals 135 may be formed before and/or after attachment of Sealing Layer 130. In various embodiments, Seals 135 are configured to reduce diffusion of Attractants 120 between Compartments 110 to a factor of at least 100, 1000 or 10,000 times less than the diffusion out of Compartments 110 (through Diffusion Membranes 125) when Sealing Layer 130 is removed.

Attractants 120 may include any compounds known to attract insects. Generally, the purpose of dividing Attractants 120 between more than one of Compartments 110 is to prevent different Attractants 120 from reacting with each other. For example, in some embodiments acidic Attractants 120 are placed in Compartment 110A and Attractants 120 having an alcohol moiety are placed in Compartment 110B.

In addition to acids and alcohols, Attractants 120 optionally further include esters and/or other compounds found to attract insects. As used herein, acidic is used to refer to a compound having a pH less than 7; alcohol is used to refer to an organic compound having a hydroxyl functional group (—OH) bound to a saturated carbon atom; “ester” is used to refer to chemical compounds derivable from an acid (organic or inorganic) in which at least one —OH (hydroxyl) group is replaced by an —O-alkyl (alkoxy) group. Examples of compounds that may be included in Attractants 120 are listed in Tables II, III and IV. In addition to those listed in these tables, any suitable ester, saturated alcohol and/or saturated carboxylic acid may be used as an attractant. Further, in addition to those listed in Table IV, the esters used as attractants optionally include any suitable mono- or di-unsaturated compounds of up to 12 carbon atoms. In various embodiments, these saturated alcohol and/or saturated carboxylic acid include up to 4, up to 6 or up to 10 carbon atoms. Some embodiments further include attractants including mono or di-unsaturated compounds of up to 6 carbons.

TABLE II
Acids
Acidic Compounds

Acetic Acid
Formic Acid
Propionic Acid

TABLE III
Alcohols
Alcohols

| | |
|---|---|
| Ethanol | Methanol |
| Acetoin | Propanol |
| Methionol | Iso-propanol |
| Ethyl lactate | Iso-butanol |
| 1-hexanol | Tert-butanol |
| Grape butyrate | 3-hydroxybutan-2-one |
| Isoamyl lactate | 3-methylsulfanylpropan-1-ol |
| 2-phenylethanol | |

TABLE IV
Esters
Esters

| | |
|---|---|
| Isoamyl acetate | 3-hydroxybutan-2-yl |
| | formate |
| 2-methylbutyl acetate | 3-hydroxybutan-2-yl |
| | acetate |
| Ethyl sorbate | 3-hydroxybutan-2-yl |
| | propionate |
| Ethyl acetate | 3-hydroxybutan-2-yl |
| | butylate |
| Diethyl succinate | 3-methylsulfanylpropan- |
| | 1-yl formate |
| Ethyl butyrate | 3-methylsulfanylpropan- |
| | 1-yl acetate |
| 3-methylsulfanylpropan- | 3-methylsulfanylpropan- |
| 1-yl propionate | 1-yl butylate |
| Ethyl lactate | Grape butyrate |
| Isoamyl lactate | |

In various embodiments, Lure 100 includes at least two Compartments 110A and 110B. Acetic acid is disposed in Compartment 110A and any two, three or more of the compounds listed in Table III are disposed in Compartment 110B. In various embodiments, Lure 100 includes at least three Compartments 110A, 110B and 110C. Acetic acid is disposed in Compartment 110A; ethanol is disposed in Compartment 110B; and acetoin and methionol are disposed in Compartment 110C. In various embodiments, Lure 110 includes at least three Compartments 110A, 110B and 110C; acetic acid is disposed in Compartment 110A; a first of the compounds listed in Table III is disposed in Compartment 110B; and at least a second and third of the compounds listed in Table III disposed in Compartment 110C. In various embodiments, a Lure 100 includes at least four Compartment 110; acetic acid disposed in a first of Compartments 110; ethanol is disposed in a second of Compartments 110; acetoin is disposed in a third of Compartments 110; and methionol is disposed in a fourth of Compartments 110. Acetoin is a solid dimer at room temp, so water, ethylene glycol, propylene glycol and other diluents can be added as a solvent. In some embodiments the solvent is selected for the resulting mixture to have an equivalent or higher vapor pressure than the solvent alone. Attractants 120 can be in solid or liquid form. The order of Compartments 110A, 110B and 110C is typically not important, and as used herein the identification of them as “first-second” or “110A-110B” etc. is not meant to indicate a requirement for an actual physical order.

The lures used in Compartment 110A-110C are optionally configured to attract one or more of the insects listed in Table V.

TABLE V

| Class | Order | Family | Genus |
|---|---|---|---|
| Insecta | Coleoptera | Curculionidae | Anthonomus |
| | | | Rhynchophorus |
| | | Scarabaeidae | Anomala |
| | | | Blitopertha |
| | | | Exomala |
| | | | Popillia |
| Insecta | Diptera | Drosophilidae | Drosophila |
| | | Muscidae | Haematobia |
| | | | Musca |
| | | | Stomoxys |
| | | Tephritidae | |
| Insecta | Heteroptera | Pentatomidae | Euschistus |
| Insecta | Hymenoptera | Vespidae | Vespa |
| | | | Vespula |
| Insecta | Lepidoptera | Cacoeciamorpha | |
| | | Choristoneura | |
| | | Noctuidae | Helicoverpa |
| | | Oecophoridae | |
| | | Pyralidae | Ephestia |
| | | | Plodia |
| | | Spodoptera | |
| | | Tortricidae | Archips |
| | | | Argyrotaenia |
| | | | Cydia |
| | | | Grapholita |
| | | | Pandemis |
| | | | Platynota |

Other compounds that may be included in Compartments 100A-110C include those listed in Table VI. These compounds, and those included in Tables II-IV, are used in any combination, in various embodiments of the invention.

TABLE VI

| | | |
|---|---|---|
| Linalool | Geraniol | b-Damascenone |
| a-Ionone | Benzyl alcohol | (Z)-3-hexenol |
| a-Ionol | Raspberry ketone | acetoin |
| b-Ionone | Hexanoic acid | Butyl acetate |
| Hexanal | 2-Heptanone | 3-Methyl-1-butanol |
| trans-2-Hexenal | 3-Methyl-2-butenyl acetate | 2-Heptanol |
| Hexanol | cis-3-Hexenol acetate | 6-Methyl-5-hepten-2-ol |
| β-pinene | α-pinene | Myrcene |
| α-phellandrene | p-cimene | β-phellandrene |
| γ-terpinene | caryophyllene | Humulene |
| Geraniol | Dihydro-β-ionone | α-Ionone |
| methyl acetate | limonene | hexanoic acid ethylester |
| ethyl acetate | | |

FIG. 1B illustrates a two compartment Lure 100, according to various embodiments of the invention. In these embodiments of Lure 100, acidic Attractants 120 are optionally disposed in Compartment 110A and alcohol Attractants 120 are optionally disposed in Compartment 110B.

FIG. 1C illustrates an exploded view of a lure compartment, according to various embodiments of the invention. Note that Diffusion Membranes 125 are optionally formed by a single continuous sheet and Seals 135 penetrate this sheet.

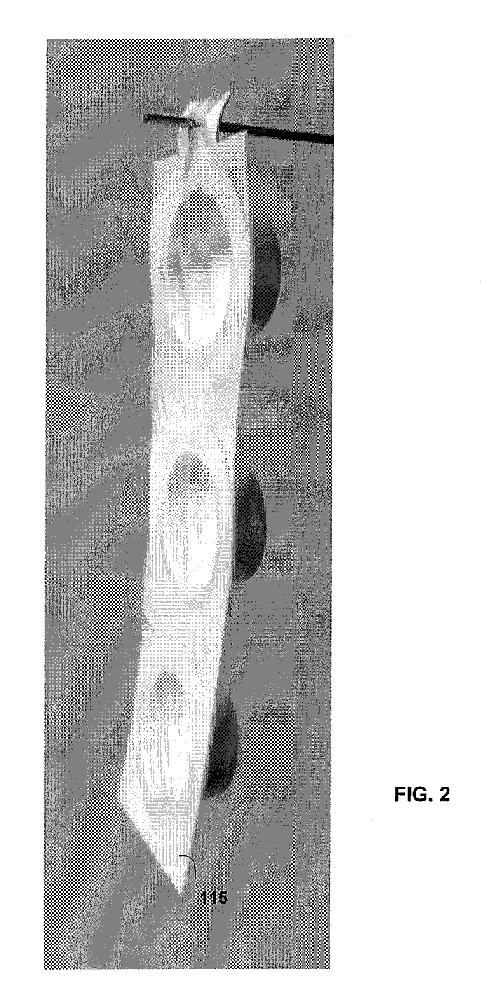

FIG. 2 illustrates the outer Shell 115 of a three compartment Lure 100, according to various embodiments of the invention. In these embodiments, Shell 115 is a gas impermeable plastic.

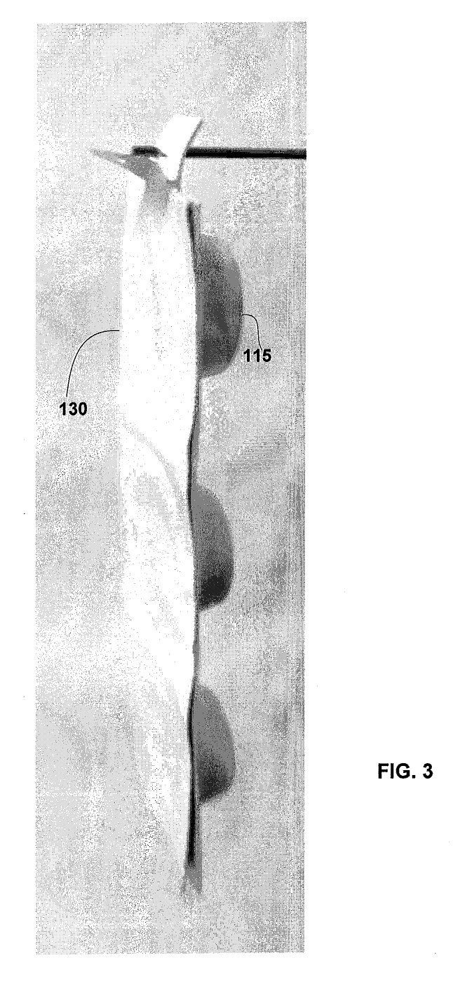

FIG. 3 illustrates an assembled three compartment Lure 100, according to various embodiments of the invention. Shell 115 and Sealing Layer 130 are visible.

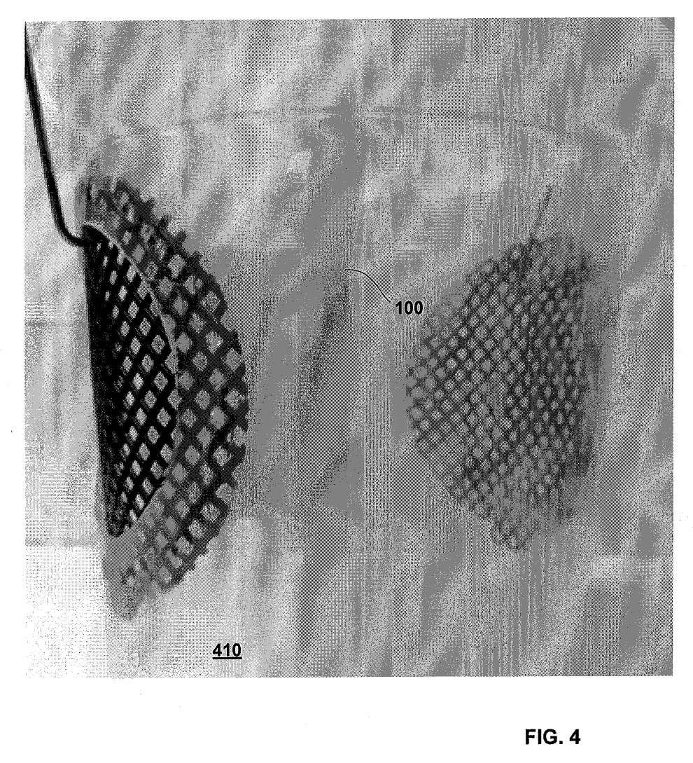

FIG. 4 illustrates a three compartment Lure 100 disposed with an insect Trap 410, according to various embodiment of the invention. As noted elsewhere herein Lure 100 is optionally included as part of a structural component of Trap 410. Trap 410 can be embodied in may alternative shapes and sizes, as will be apparent to one of ordinary skill in the art. Further, compartments of Lure 100 may be disposed inside and/or outside of Trap 410. For example, Compartment 110 A may be inside while Compartment 110B is outside, or vice versa. Two of Compartments 110 may be disposed inside while one of Compartments 110 is disposed outside, or vice versa.

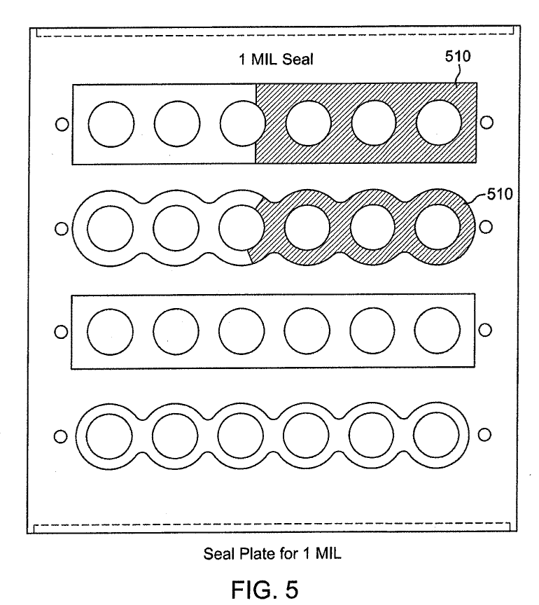

FIG. 5 illustrates Attachment Points 510 for Diffusion Membranes 125, according to various embodiments of the invention. The outlines shown are possible positions at which adhesive, pressure, solvent and/or heat are used to attached Diffusion Membranes 125 to Shell 115. This attachment may result in the generation of part of Seals 135. The dimensions are in centimeters and are meant to be illustrative, only, not limiting.

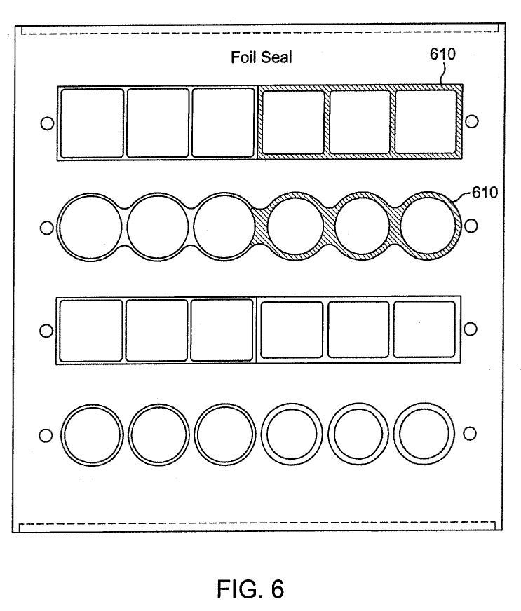

FIG. 6 illustrates Attachment Points 610 of Sealing Layer 130, according to various embodiments of the invention. For example, the outlines illustrated may be points at which adhesive, solvent, pressure and/or heat are applied attach Sealing Layer 130 to the remainder of Lure 100. This attachment may result in the generation of part of Seals 135.

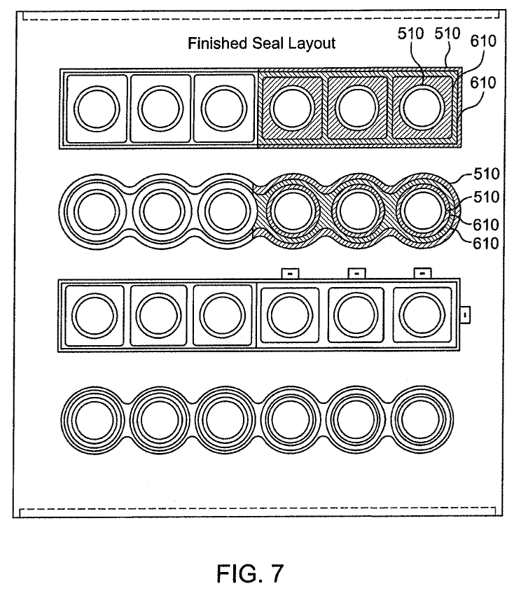

FIG. 7 illustrates an overlay of Seals 135 and/or the Attachment Points 510 and 610 shown in FIGS. 5 and 6, according to various embodiments of the invention. As illustrated in FIGS. 5-7, Shell 115 and Seals 135 can include either rectangular or curvilinear shapes.

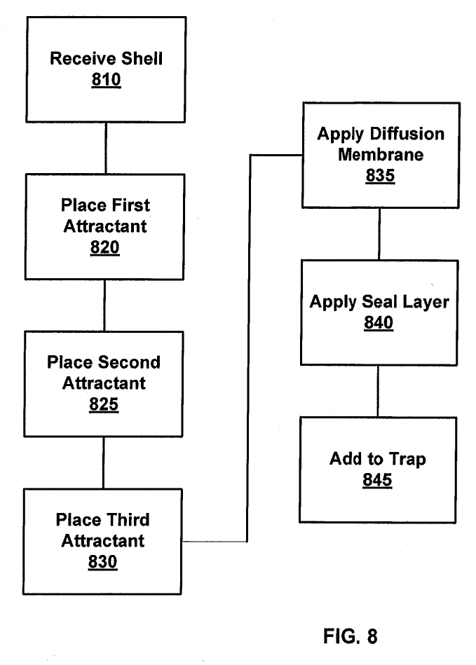

FIG. 8 illustrates methods of producing a lure and/or trap, according to various embodiments of the invention. The produced lure or trap may include any of the embodiments discussed elsewhere herein. In a Receive Shell Step 810, the method includes first receiving an instance of Shell 115. This instance of Shell 115 can include at least two, three, four or more Compartments 110. This instance of Shell 115 may also be configured to be part of Trap 410, such as a lid, wall or bottom.

In a Place First Attractant Step 820 a first insect Attractant 120A is placed in the first Compartment 120A. In various embodiments, this Attractant 120A can include any of the Attractants 120 described elsewhere herein. In a Place Second Attractant Step 825, Attractant 120B is placed in the second Compartment 120B. This Attractant 120B can include any of the Attractants 120 described herein, but is typically different than Attractant 120A. In an optional Place Third Attractant 830, Attractant 120C is placed in optional Compartment 120C. This Attractant 120C can include any of the Attractants 120 described herein, but is typically different than Attractants 120A and 120B. Similar steps may be performed for additional compartments. The results of Steps 820-830 include any of the combinations of Attractants 120 disclosed elsewhere herein. For example, Attractant 120A may comprise Acetic Acid, Attractant 120B may include Ethanol or a combination of Ethanol, Acetoin and Methionol, Attractant 120C may include a combination of Acetoin and Methionol. As discussed elsewhere herein, other useful chemicals can be added to the Compartments 110 discussed herein, or to additional compartments within Lure 100. This optionally occurs during Steps 820-830.

In an Apply Diffusion Membrane Step 835, Diffusion Membrane 125A is applied to Compartment 110A, Diffusion Membrane 125B is applied to Compartment 110B, and optionally Diffusion Membrane 125C is applied to Compartment 110C, etc. As discussed elsewhere herein, Diffusion Membranes 125 are configured to control diffusion of Attractants 120 from the respective Compartments 110.

In some embodiments the application of Diffusion Membranes 125A, 125B and 125C is performed in a single step using a single sheet of membrane. For example, a sheet of polymer membrane may be placed over Shell 115 and attached using adhesive and/or heat at the locations illustrated in FIG. 5. Alternatively, Diffusion Membranes 125 may be attached separately, allowing for the application of different Diffusion Membranes 125 on different members of Compartments 110. Diffusion Membranes 125 may be attached using pressure, heat, solvent, adhesive, and/or any other attachment mechanism known in the art.

In an Apply Seal Layer 840, removable Sealing Layer 130 is applied to Lure 100. As discussed elsewhere herein, Sealing Layer 130 is configured to seal Lure 100 and Compartments 110 so as to prevent appreciable amounts of Attractants 120 from being released from Lure 100, prior to removal of Sealing Layer 130. Sealing Layer 130 further prevents Attractant 120A from diffusing from Compartment 110A through Diffusion Membranes 125A and 125B to Compartment 110B. Sealing Layer 130 can be attached using pressure, heat, solvent, adhesive, and/or any other removable attachment mechanism known in the art. In some embodiments the Sealing Layer 130 is attached at positions illustrated in FIG. 6. Typically, Diffusion Membranes 125 are more firmly attached to Shell 115 than Sealing Layer 130 is attached to the rest of Lure 100, so that Sealing Layer 130 can be pulled off leaving Diffusion Membranes 125 intact.

In some embodiments, the attachment of Diffusion Membranes 125 and/or Sealing Layer 130 results in the formation of Seals 135. For example, the attachment of these elements can result in a diffusion path from Compartment 110A to Compartment 110B through Diffusion Membranes 125A and 125B that is tenths of an inch, this effectively eliminates diffusion between these two compartments, e.g., it effectively seals the Compartments 110 from each other. The effective elimination of diffusion between Compartments 110 significantly limits chemical reactions between Attractants 120 from different Compartments 110 to inconsequential trace levels that do not impact the shelf life of Lure 100. These reactions are prevent from occurring in other than trace, inconsequential amounts.

In an optional Add to Trap Step 845, Lure 100 is added to Trap 410. Lure 100 can be hung in Trap 410 as illustrated in FIG. 4 or attached by some other means. If Lure 100 includes an integral part of Trap 410, then Add to Trap Step 845 includes assembly of Trap 410.

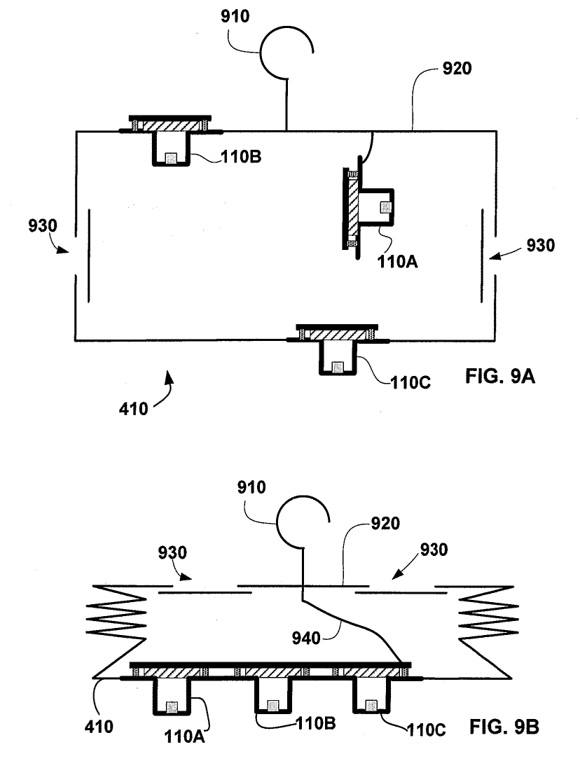

FIGS. 9A and 9B illustrate instances insect Trap 410 including one or more Lures 100, according to various embodiments of the invention. These figures provide examples of how Compartments 110 may be integrated into instances of Traps 410. While the Compartments are labeled 110A, 110B and 110C, these can be interchanged in various embodiments, and the illustrated positions of specific Compartments 110 is not intended to be limiting.

In FIG. 9A, Trap 410 is shown to include a Hanger Hook 910, a Container 920, Insect Entrances 930 and three Compartments 110. For the purposes of example, Compartment 110A is shown hanging within the interior of Trap 410. Optionally, two, three or more Compartments 110 can be attached using this approach, with the Compartments 110 connected and/or separate. Compartments 110B and 110C are shown integrated in to a wall of Trap 410. For the purposes of example, Compartment 110B is shown at the exterior of Trap 410 and configured such that the attractant from this container will diffuse to the exterior of Trap 410 when Sealing Layer 130 is removed. Two, three or more of the Compartments 110 are optionally configured thus. For the purposes of example, Compartments 110C is shown configured such that the attractant from this container will diffuse into the interior of Trap 410 when Sealing Layer 130 is removed. Two, three or more of the Compartments 110 are optionally configured thus. Sealing Layer 130 is optionally removed prior to inserting Compartments 110 into Trap 410. However Compartments 110 are disposed with Trap 410, they may be connected directly or separate.

FIG. 9B illustrates a folded embodiment of Trap 410. This embodiment is configured to be pulled such that it unfolds, e.g., pulled by Hanger Hook 910. This action optionally causes Ribbon 940, connected to Hanger Hook 910 to pull Sealing Layer 130 from Compartments 110. One of ordinary skill in the art will understand, with the benefit of this specification, that there are many ways in which Compartments 110 can be incorporated into Traps 410 and in which Sealing Layer 130 may be automatically or manually removed. For example, Sealing Layer 130 may be broken by screwing, snapping, clipping or other attachment of Lure 100 into Trap 410. Sealing Layer 130 need not be removed completely to effect “removal.” The sealing property merely needs to be breached. Trap 410 is optionally configured for replacement of Lure 100.

Several embodiments are specifically illustrated and/or described herein. However, it will be appreciated that modifications and variations are covered by the above teachings and within the scope of the appended claims without departing from the spirit and intended scope thereof. For example, Lures 100 can include additional Compartments 110 and can contain compounds other that insect attractants. These compounds can include: dyes, chemical markers, insect trapping adhesives, materials for inset control, insecticides, pheromones, kairomones and/or necromones.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. An insect control device comprising:
a shell including a first compartment and a second compartment, the first and second compartment being configured to hold attractant compounds;
two or more insect attractant compounds, the insect attractant compounds including one or more acidic attractant compounds and one or more alcohol attractant compounds including an alcohol, the acidic attractant compounds being disposed in the first compartment and the alcohol attractant compounds being disposed in the second compartment;
a first diffusion membrane configured to control release of the acidic attractant compounds from the first compartment; and
a removable sealing layer configured to seal the first compartment and the second compartment.

2. The device of claim 1, further comprising:
a second diffusion membrane configured to limit diffusion of the one or more alcohol attractant compounds from the second compartment, the second diffusion membrane being different than the first diffusion membrane.

3. (canceled)

4. The device of claim 1, wherein the first diffusion membrane and the removable sealing layer are configured to prevent significant chemical reaction between the acidic attractant compounds and the alcohol attractant compounds.

5. The device of claim 1, wherein the first diffusion membrane has a thickness of less than 10 thousandths of an inch.

6. The device of claim 1, wherein the one or more acidic attractant compounds include Acetic Acid.

7. The device of claim 1, wherein the one or more alcohol attractant compounds includes at least one compound listed in Table III.

8. The device of claim 1, wherein the one or more alcohol attractant compounds includes at least two compounds listed in Table III.

9. The device of claim 1, wherein the one or more alcohol attractant compounds include ethanol, acetoin and methionol.

10. The device of claim 1, wherein the one or more alcohol attractant compounds include ethanol, acetoin or methionol.

11. The device of claim 1, wherein the one or more alcohol attractant compounds include at least two of ethanol, acetoin and methionol.

12. The device of claim 1, wherein the one or more alcohol attractant compounds include acetoin and a solvent.

13. The device of claim 1, further comprising at least one of the esters listed in Table IV, the at least one ester being disposed in the first or second compartment.

14. The device of claim 1, further comprising a third compartment and one or more insect attractant compounds disposed within the third compartment, the insect attractant compounds in the first, second and third compartments being different.

15. The device of claim 14, wherein the one or more insect attractant compounds in the third compartment includes an ester or an alcohol.

16. The device of claim 14, wherein the one or more insect attractant compounds in the third compartment includes one of the esters listed in Table IV or an alcohol listed in Table III.

17. The device of claim 14, wherein the one or more insect attractant compounds in the second compartment includes ethanol, and the one or more insect attractant compounds in the third compartment includes acetoin and methionol.

18. The device of claim 1, further comprising a container configured to trap insects.

19. The device of claim 1, wherein the one or more acidic attractant includes a saturated carboxylic acid having 6 or less carbon atoms.

20. The device of claim 1, wherein the one or more alcohol attractant compounds include a alcohol having 6 or less carbon atoms.

21-25. (canceled)

26. The device of claim 14, wherein the one or more insect attractant compounds in the first compartment include acetic acid, the one or more insect attractant compounds in the second compartment includes ethanol, and the one or more insect attractant compounds in the third compartment includes acetoin and methionol.

27-34. (canceled)

35. The device of claim 14, wherein the one or more insect attractant compounds in the third compartment includes acetoin and methionol.

36. The device of claim 14, wherein the one or more insect attractant compounds in the third compartment include acetoin.

37-39. (canceled)

40. The device of claim 1, wherein the removable sealing layer includes a metal foil.

41-42. (canceled)

43. A method of producing an insect lure, the method comprising:
receiving a shell including at least a first compartment and a second compartment;
placing a first insect attractant in the first compartment, the first insect attractant including acetic acid;
placing a second insect attractant in the second compartment, the second insect attractant including at least one compound listed in Table III;
applying a first diffusion membrane to the first compartment, the first diffusion membrane being configured to limit diffusion of the first insect attractant from the first compartment;
applying a second diffusion membrane to the second compartment, the second diffusion membrane being configured to limit diffusion of the second insect attractant from the second compartment;
applying a removable sealing layer to the insect lure, the removable sealing layer being configured to seal the first and second compartments; and
creating a seal between the first compartment and the second compartment, the seal being configured to limit a chemical reaction between the first insect attractant and the second insect attractant.

44. The method of claim 43, wherein the shell includes a third compartment, and the method further comprises placing a third insect attractant in the third compartment, the first, second and third insect attractants being different.

45-52. (canceled)

53. The method of claim 44, wherein the third insect attractant includes acetoin or methionol.

54-55. (canceled)

56. The method of claim 44, wherein the insect attractant compounds in the first, second, or third compartment further includes an ester.

57-68. (canceled)

69. The device of claim 18, wherein one of the first and second compartments is configured for one of the insect attractants to diffuse into an interior of the container and the other of the first and second compartments is configured for one of the insect attractants to diffuse to an exterior of the container.

70-73. (canceled)

74. The device of claim 2, wherein the second diffusion membrane includes a pore size, a material or a thickness different from the first diffusion membrane.
